(19) United States
(12) Patent Application Publication
(10) Pub. No.: US 2019/0302779 A1
(43) Pub. Date: Oct. 3, 2019

(54) TARGET CONTROL METHOD, DEVICE AND SYSTEM

(71) Applicant: CLOUDMINDS (SHENZHEN) ROBOTICS SYSTEMS CO., LTD., Shenzhen (CN)

(72) Inventor: Lei LUO, Shenzhen (CN)

(73) Assignee: CLOUDMINDS (SHENZHEN) ROBOTICS SYSTEMS CO., LTD., Shenzhen (CN)

(21) Appl. No.: 16/428,996

(22) Filed: Jun. 1, 2019

Related U.S. Application Data
(63) Continuation of application No. PCT/CN2016/110567, filed on Dec. 17, 2016.

(51) Int. Cl. G05D 1/02; G06F 9/48

(52) U.S. Cl. CPC G05D 1/0212; G05D 2201/0217; G05D 1/0274; G06F 9/4818

(57) ABSTRACT

A method for controlling a target includes obtaining a present position of the target. Then based on the present position of the target, at least one member is selected for controlling the target. A designated location where and a designated time when each selected member shall arrive to control the target is determined and then sent to the each selected member for notification. A device for implementing the method and a system executing the control can facilitate members designated for controlling a target being selected and coordinated in a global, real-time, and dynamic manner based on a present global state during the movement of the target.

### CROSS-REFERENCE TO RELATED APPLICATION

The present application is a continuation of International Patent Application No. PCT/CN2016/110567 filed on Dec. 17, 2016, the disclosure of which is incorporated by reference herein in its entirety.

### BACKGROUND

The field of robots develops rapidly at present, and it is expected that robots will replace human beings in many industries several years later. Based on conventional technologies, the implementation of control over a target, such as patrolling to search for, chasing, or rescuing the target, is almost completed manually all by humans. Conventional control approaches typically consume high manpower, have low efficiency, have lower accuracy of identification than approaches using machine algorithms, and have a risk of injury. As such, it is very likely that target control becomes a field where humans can be replaced very early with robots, unmanned aerial vehicles and the like.

### SUMMARY

The application relates to the technical field of intelligent control, and particularly to a target control method, a control device and a control apparatus.

In a first aspect, a method for controlling a target in a task is provided. The method comprises the following steps:

acquiring a present position of the target; and

selecting, based on the present position of the target, at least one member designated for controlling the target, and determining a designated location where and a designated time when each of the at least one member shall arrive for controlling the target, and notifying the designated location and the designated time to the each selected member.

Herein the designated location is referred to as a location where the target can be controlled by a particular selected member, and the designated time is referred to as a time when the particular selected member shall arrive at the designated location.

According to some embodiments of the method, the step of acquiring a present position of the target comprises: obtaining, on a map, coordinates of the present position of the target and coordinates of branch points. Herein, the branch points comprise at least 1^{st}-level branch points. In the at least one member designated for controlling the target, a different member is selected for each of the branch points.

Herein, each branch point is referred to as a location allowing the target to be controlled by any of the at least one control member.

In the method, the step of selecting, based on the present position of the target, at least one member designated for controlling the target, and determining a designated location where and a designated time when each of the at least one member shall arrive for controlling the target, and notifying the designated location and the designated time to the each selected member can include the following sub-steps:

examining, for each 1^{st}-level branch point, whether one or more members is capable of arriving at the each 1^{st}-level branch point before the target arrives at a present maximum velocity; and

if so, selecting one of the one or more members as one of the at least one member designated for controlling the target at the each 1^{st}-level branch point;

or otherwise, performing at least one round of searching and examining corresponding to higher-level branch points.

Herein one of the at least one round of searching and examining corresponding to i^{th}-level branch points can optionally include:

examining, for each i^{th}-level branch point, whether one or more members is capable of arriving at the each i^{th}-level branch point before the target arrives at a present maximum velocity; and

if so, selecting one of the one or more members as one of the at least one member designated for controlling the target at the each i^{th}-level branch point;

otherwise, performing another round of searching and examining corresponding to (i+1)^{th}-level branch points.

In the above, i is an integer more than one.

More specifically, if no member is capable of arriving at any 1^{st}-level branch point before the target arrives at the present maximum velocity, the step of selecting, based on the present position of the target, at least one member designated for controlling the target, and determining a designated location where and a designated time when each of the at least one member shall arrive for controlling the target, and notifying the designated location and the designated time to the each selected member includes the following sub-steps:

searching for 2^{nd}-level branch points of the any 1^{st}-level branch point;

examining, for each 2^{nd}-level branch point, whether one or more members is capable of arriving at the each 1^{st}-level branch point before the target arrives at a present maximum velocity; and

if so, selecting one of the one or more members as one of the at least one member designated for controlling the target at the each 2^{nd}-level branch point.

Yet if no member is capable of arriving at any 2^{nd}-level branch point before the target arrives at the present maximum velocity, the step of selecting, based on the present position of the target, at least one member designated for controlling the target, and determining a designated location where and a designated time when each of the at least one member shall arrive for controlling the target, and notifying the designated location and the designated time to the each selected member includes:

searching for 2^{nd}-level branch points of the any 1^{st}-level branch point;

examining, for each 2^{nd}-level branch point, whether one or more members is capable of arriving at the each 1^{st}-level branch point before the target arrives at a present maximum velocity; and

if so, selecting one of the one or more members as one of the at least one member designated for controlling the target at the each 2^{nd}-level branch point; or otherwise

continuing searching for immediate next-level branch points until the target can be controlled at one branch point or a number of levels of the branch points reaches a threshold value.

Optionally, the performing at least one round of searching and examining continues until the target can be controlled at the branch points or until a number of levels of the branch points reaches a first threshold value. Herein, the first threshold value can be pre-determined according to a priority of the task.

According to some embodiments of the method, the step of selecting, based on the present position of the target, at least one member designated for controlling the target, and determining a designated location where and a designated time when each of the at least one member shall arrive for controlling the target, and notifying the designated location and the designated time to the each selected member can include the following sub-steps:

determining, for each of the branch points, whether one or more members in an idle state can be selected; and

if so, preferably selecting one of the one or more members for controlling the target at the each of the branch points; otherwise

selecting another member on another task having a lower priority for controlling the target at the each of the branch points.

Herein, optionally, the selecting another member on another task having a lower priority for controlling the target at the each of the branch points can include:

examining whether a probability of completing the another task if the another member quits the another task is no lower than a second threshold value; and

if so, notifying the another member to quit the another task and join the task;

or otherwise, maintaining the another member in the another task.

According to some embodiments, prior to the step of selecting, based on the present position of the target, at least one member designated for controlling the target, and determining a designated location where and a designated time when each of the at least one member shall arrive for controlling the target, and notifying the designated location and the designated time to the each selected member, the method further includes a step of setting a priority for the task based on information about the target.

As such, the step of selecting, based on the present position of the target, at least one member designated for controlling the target, and determining a designated location where and a designated time when each of the at least one member shall arrive for controlling the target, and notifying the designated location and the designated time to the each selected member includes: estimating, based on the priority for the task, a number of at least one member and a minimum capability for each of the at least one member required for the task.

According to some embodiments, the method further includes a step of altering a state of each of the at least one member designated for controlling the target into an idle state or a previous state upon completing of the task.

If any one of the at least one member arrives at a higher-level branch point, the method further includes the following steps:

cancelling a control over the target at each lower-level branch point subdivided from the higher-level branch point; and

notifying each of the at least one member designated for each lower-level branch point to enter into an idle state or a previous state.

According to some embodiments of the method, during the process of searching and examination for a certain branch point, if searching and examination have been previously performed for a branch point, the searching and examination for the branch point is skipped.

Optionally, when any one of the at least one member arrives at a corresponding branch point but the target has yet arrived, the method can further include a step of notifying the any one of the at least one member to continue moving towards the target until meeting with the target.

Furthermore, optionally in the method, if a member is between the primary branch point to which it is allocated and the target or the target is between the selected member and the primary branch point to which it is allocated, the member is confirmed and notified to arrive at the branch point before the target arrives at the primary branch point rather than rush to the primary branch point within shortest time.

Furthermore, optionally in the method, if a selected member is between an i^{th}-level branch point and an (i−1)^{th}-level branch point when the member is selected for the i^{th}-level branch point, the member is confirmed and notified to preferably move to the (i−1)^{th}-level branch point rather than arrive at the i^{th}-level branch point at first, i≥2.

Any one embodiment of the method described above can be applied in situations where one or more of the at least one member is a robot, but can also be more generally applied in situations where each of the at least one member is a human agent, such as a policeman.

In a second aspect, a device for allocating a task to a group of candidate members communicatively connected thereto to control a target is provided, which is configured to substantially implement each step of the above target control method according to any of the various embodiments as described above.

The device includes a target acquisition module, a control module, and a notification module. The target acquisition module is configured to acquire a present position of the target; the control module configured, based on the present position of the target, to select from the group of candidate members at least one member designated for the task, and to determine a designated location where and a designated time when each of the at least one member shall arrive for controlling the target; and the notification module is configured to notify the designated location and the designated time to the each selected member.

Optionally, the target acquisition module is configured to obtain, on a map, coordinates of the present position of the target and coordinates of branch points. Herein the branch points comprise at least 1st-level branch points, and the control module is configured to select a different member for each of the branch points.

According to some embodiments of the device, the control module is configured:

to examine, for each 1^{st}-level branch point, whether one or more members is capable of arriving at the each 1^{st}-level branch point before the target arrives at a present maximum velocity; and

if so, to select one of the one or more members as one of the at least one member designated for controlling the target at the each 1^{st}-level branch point;

or otherwise, to perform at least one round of searching and examining corresponding to higher-level branch points. Herein, one of the at least one round of searching and examining corresponding to i^{th}-level branch points comprises:

examining, for each i^{th}-level branch point, whether one or more members is capable of arriving at the each i^{th}-level branch point before the target arrives at a present maximum velocity; and

if so, selecting one of the one or more members as one of the at least one member designated for controlling the target at the each i^{th}-level branch point;

otherwise, performing another round of searching and examining corresponding to (i+1)^{th}-level branch points;

Herein i is an integer more than one.

The device can, according to some embodiments, further include a setting module, which is configured to set a priority for the task based on information about the target. In accordance, the control module is further configured to estimate, based on the priority for the task, a number of at least one member and a minimum capability for each of the at least one member required for the task.

The device can, according to some embodiments, further include a setting module, which is configured to set a priority for the task based on information about the target, and the control module is further configured:

to determine, for each of the branch points, whether one or more members in an idle state can be selected; and

if so, the setting module is configured to preferably select one of the one or more members for controlling the target at the each of the branch points;

or otherwise, is configured to select another member on another task having a lower priority for controlling the target at the each of the branch points.

According to some embodiments of the device, the control module is further configured, if any one of the at least one member arrives at a higher-level branch point, to cancel a control over the target at each lower-level branch point subdivided from the higher-level branch point; and the notification module is further configured to notify each of the at least one member designated for each lower-level branch point to enter into an idle state or a previous state.

In practice, the above device can comprise a computing system including one or more processors, and a memory communicatively connected to the one or more processors by, for example, a communication bus. The one or more processors are configured to execute instructions in the memory, and the instructions can be organized in modules such as those described above in the device, each configured to execute the operations described above. The device can be a server in an intranet, in the Internet, or can be in a cloud.

In a third aspect, the present disclosure further provides a system for controlling a target. The system includes a control terminal and a group of candidate members. Each candidate member is communicatively connected to the control terminal, and is configured to control the target under control of the control terminal. Herein, the control terminal can comprise a device according to any one of the embodiments described above.

Optionally, the control terminal can be a server in the Internet, or can be a server in an intranet, or can be just in a cloud.

Herein, one or more of the group of candidate members can be a robot.

In a fourth aspect, the present disclosure provides a computer-readable storage medium, which can be used in combination with the device mentioned above.

The computer-readable storage medium stores one or more computer programs, each comprising instructions configured to enable a computing system, such as the aforementioned device to execute each step of the target control method as set forth above.

According to yet another aspect, the embodiments of the present disclosure provide a target control apparatus, which may include a processor and a communication component.

The processor is configured to acquire a present position of the target, and according to the present position of the target, to select members designated for controlling the target, and to determine a designated position where each member shall arrive and a designated time when each member shall arrive at the designated position.

The communication component is configured to notify the designated position and the designated time to the each member.

### BRIEF DESCRIPTION OF DRAWINGS

Specific embodiments of the present disclosure will be described below with reference to the drawings.

FIG. 1 is a schematic diagram of a hypothesized target control scenario according to some embodiment of the disclosure.

FIG. 2 is a flow chart of a target control method according to some embodiment of the present disclosure.

FIG. 3 is a structure diagram of a target control device according to some embodiment of the present disclosure.

FIG. 4 is a structure diagram of a target control apparatus according to some embodiment of the present disclosure.

### DETAILED DESCRIPTION

In order to make the technical solutions and advantages of the present disclosure clearer, exemplary embodiments of the present disclosure will further be described below in combination with the drawings in detail. It is apparent that the described embodiments are not all embodiments but only part of embodiments of the present disclosure. Moreover, the embodiments in the present disclosure and characteristics in the embodiments may be combined without conflicts.

The inventor the present disclosure has recognized that, particularly after a target coordinate is determined, a person is required at present to complete the final control work (for example, blocking, chasing and rescuing, etc.), yet certain inborn characteristics of humans, such as a weak eyesight in darkness and relatively low speed for searching the target with eyes, have limited the success rate of target control. In addition, if a target person is armed or the target is a robot, a process of implementing control is highly risky.

In the conventional art, the task of controlling a target is typically completed all manually by humans, and for this manner of human control or manual control, due to the limitations on the number and physical strength of the personnel, the route, time, frequency, and density may not completely meet the requirements. In addition, for human control, information such as a scene image may not be transmitted back to a monitoring center in real time, thus bringing inconvenience to the commanding and decision making during an emergency. Moreover, the manner of human control has a low success rate, and can threaten the safety of humans. Therefore, there are relatively great limitations to this manner.

In light of these above, embodiments of the disclosure provide a target control method, a control device, a control apparatus and a computer-readable storage medium. Briefly, according to a present position of the target, all of the members designated for controlling a target (i.e. designated members) can be determined, and a location where each designated member shall arrive (i.e. designated location), and a time when each designated member shall arrive (i.e. designated time) at the designated location, can further be determined and then sent to the each designated member. Herein, the designated location is defined as a location where the target can be controlled. Some or all of the designated members for controlling the target can be robots. Accordingly, the members designated for controlling a target can be universally coordinated in a real-time and dynamic manner based on a present global state during the movement process of the target. Herein, controlling over the target can be blocking, chasing, rescuing, etc., over the target. In the following, detailed descriptions will be provided.

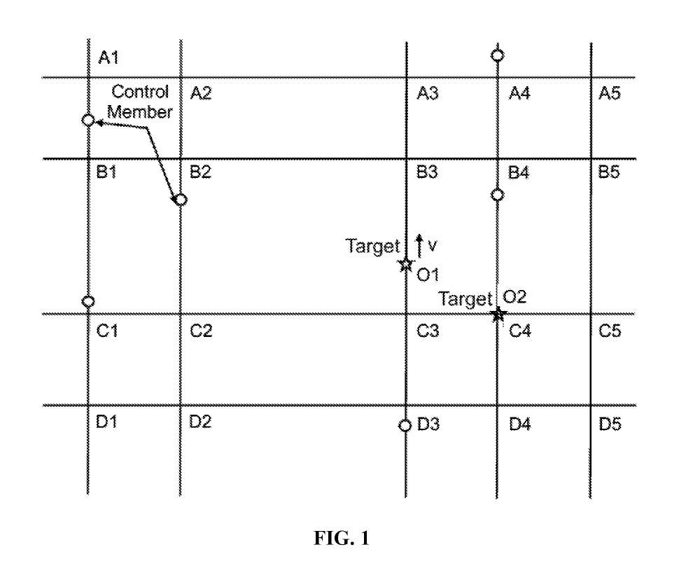

FIG. 1 is a schematic diagram of a target control scenario according to an embodiment of the disclosure. Herein the target control scenario is a hypothesized scenario, with FIG. 1 showing a top view of streets at a moment. Intersections of every two streets are marked with letters respectively. It is assumed that a target is presently at the point O1 between B3 and C3 and is moving towards B3 at a velocity v. In the figure, white circles represent control members with a task or in an idle state.

### Embodiment 1

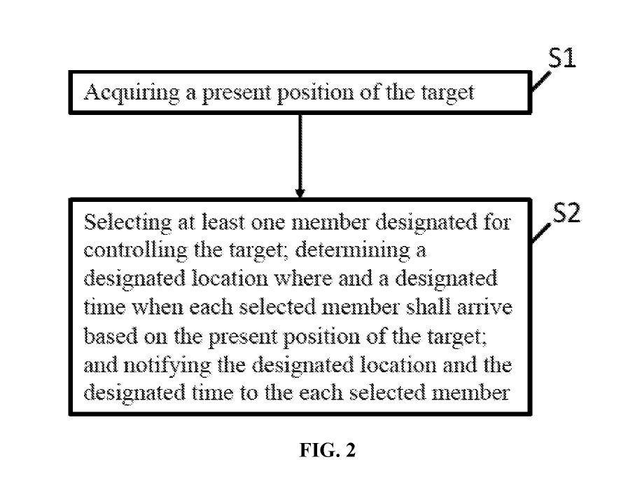

As shown in FIG. 2, a method for controlling a target can include the following steps.

In Step 1, a present position of the target is acquired.

In this step, a controller (e.g., in a cloud) implementing the control of the target can monitor the target and determine a present position thereof, and can also acquire the present position of the target that has been determined through another way. There are no limitations herein.

In Step 2, at least one member designated for controlling the target is determined, and a designated location where and a designated time when each designated member shall arrive are determined based on the present position of the target and the designated location and the designated time are notified to the each selected member. Herein, the designated location is configured as a location where the target can be controlled. Some or all of the designated members for controlling the target can be robots. Controlling over the target can be blocking, chasing, rescuing, etc., over the target.

In Step 1, the operation that the present position of the target is acquired can specifically include:

acquiring the present position of the target and at least primary branch points on a map.

Herein, the at least primary branch points are positions where the members may control the target. The primary branch points can be determined in the following manner.

(1) When the target is on a certain road (and not at an intersection), an intersection immediately next to the target on this road is a primary branch point. As shown in FIG. 1, if the present position of the target is at point O1, the primary branch points are B3 and C3.

(2) When the target is at an intersection of two or more roads, an intersection adjacent to the target on each road where the target is located is a primary branch point. As shown in FIG. 1, if the present position of the target is at point O2, the primary branch points are C3, C5, B4 and D4.

In Step 2, the determination of the at least one member designated for controlling the target based on the present position of the target can include the following sub-steps.

In Step 21, a maximum possible average movement velocity (i.e. speed) vmax of the target within a period of time is determined based on a target image and map related information including a road condition. Assuming that there are n primary branch points for controlling the target, a shortest time required for the target to move to each primary branch point m can be determined according to vmax. As shown in FIG. 1, the shortest time required for the target to move from point O1 to point B3 and point C3 is tB3 and tC3, respectively. Assuming that a distance between point O1 and point B3 is O1B3, and a distance between the point O1 and the point C3 is O1C3, then, tB3=O1B3/vmax and tC3=O1C3/vmax.

In this step, if the controller (for example, the cloud) cannot determine the maximum possible average movement velocity of the target within the period of time, an empirical value of vmax may be provided according to, but not limited to, a present velocity v of the target and a form of the target. The empirical value may be obtained by big data-based historical statistics regarding numerous targets.

In Step 22, members close to each primary branch point are checked to examine whether at least one member can move to the each primary branch point within the shortest time, i.e. calculating whether a time period for which any of the at least one member arrives at the each primary branch point at an average velocity does not exceed the shortest time. Herein the shortest time is the time period for which the target arrives at the each primary branch point at a present maximum velocity. If YES, Step 23 is executed; otherwise Step 24 is executed.

In the step, at the controller, information about each member, such as a maximum velocity and average velocity for executing tasks, can be stored, and members selected for each branch point by the controller can be different members.

In Step 23, the at least one member is selected to execute a control task on the target, and each of the at least one selected member is notified to rush to the primary branch point within the shortest time. Herein, the shortest time is the time for which the target arrives at the branch point at the present maximum velocity.

In Step 24, if no member can rush to any one primary branch point within the shortest time, branch points that are at the next level of the primary branch point (i.e., secondary branch points) are searched to examine whether at least one member close to each secondary branch point can arrive before the target arrives at the each secondary branch point. If YES, Step 25 is executed, otherwise Step 26 is executed.

In the step, the members selected for each branch point are different members. A secondary branch point is an immediate next intersection that is far away from the target on the road where the primary branch point is located. As shown in FIG. 1, if no member can rush to the primary branch point B3 for the target 01 before the target arrives at the primary branch point B3 at a present maximum velocity thereof, secondary branch points for the primary branch point B3, including points B2, A3 and B4, will be checked.

In Step 25, if YES, at least one member is selected to execute the control task on the target, and the selected member is notified to rush to the secondary branch point before the target arrives at the point.

In Step 26, if no member can rush to any one secondary branch point before the target arrives at the point to thereby realize the control (e.g., blocking) of the target at the point, branch points at an immediate next level of the any one secondary branch point are continued to be searched, to examine whether the next-level branch points meet a control requirement (i.e. whether there is at least one member capable of rushing to the point before the target arrives at the point); and such operations are proceeded according to the above method until the target can be controlled at one branch point or until a searched branch point level reaches a pre-set threshold value. A specific maximum number of branch point levels to be searched can be flexibly set based on factors such as a specific task and a terrain. There are no limitations in the present disclosure. The maximum number of branch point levels to be searched is the pre-set threshold value, and can be set to be different for tasks with different priorities. After the pre-set threshold value is reached, the control may not be realized. Then, the search can be made back again on the primary branch points to determine or judge whether control can be realized at any of the primary branch points. If control cannot be realized under a present condition, then a chasing is still adopted first. The calculation is real time, and positions of the target on the map continuously change, thus the target may be controlled at a certain moment. During searching and examining whether there is at least one member capable of controlling the target at a certain branch point, if the branch point has been searched and examined before, searching and examination may not further be performed.

Assuming that the present task is to chase the target O1. For the target O1, if one or more members in an idle state in a chasing candidate team can arrive at the point C3 within the time tC3, one or more members can arrive at the point B2 within the time tB2, one or more members can arrive at the point A3 within the time tA3, and one or more members can arrive at the point B4 within the time tB4, then the control over the target O1 can be realized. All of tC3, tB2, tA3 and tB4 are the shortest time for which the target O1 rushes to the corresponding branch points.

Furthermore, in the embodiment, priorities can be given or assigned for different target control tasks. The target control tasks are divided into N priorities. How to divide the priorities and quality and equipment required by each member during execution of the tasks may specifically be determined according to a practical condition, and there are no limitations in the present disclosure. It is to be noted that, if there are more priorities, the target levels are subdivided more, and an intelligence level is higher. Yet this also depends on the practical condition, and excessive division of priorities could make initial priority definitions relatively complex.

During specific implementation, the number of members required by the control task and/or the amount of equipment to be carried can be analyzed and estimated based on the identified target. For example, the present task is to arrest the target, and if it is identified that the target probably has a gun or another weapon, it is determined that weapons and equipment capable of subduing the target are required to be carried; and if it is identified that the target is one or more suspicious robots, weakness of the/these robots and a method for subduing it/them can be analyzed and determined intelligently or based on a big database. For example, how to destroy the movability thereof most easily, how to cut off the power supply thereof most easily, and how to interfere with the initialization of a self-destruction device therein most easily, can be determined. Further in accordance, the members capable of restricting the capabilities of the robot can then be determined.

For example, assuming that the priority of the present task is determined as level 2 and some capabilities are required to complete the control task, such as implementing an arresting (e.g., a highest velocity needs to be at least 2*v, and a weapon is required to be carried).

Furthermore, in the process of selecting members for the primary branch points, and the secondary branch points, etc. in Step 22 and Step 24, the members in the idle state are preferably selected. If none of the presently idle members can arrive at the points before the target reaches the points, at least one member can be selected from members that are presently executing another task with a relatively low priority to execute the task, and can preferably be selected from members executing a task with a lowest priority. If no members in each other task with low priorities can arrive before the target reach the branch points at the present maximum velocity, the next-level branch points of the branch points can be searched.

Furthermore, in the process, after a certain member is selected to execute the target control task, a state of the member can be updated, and the priority of the task executed thereby can be recorded.

Furthermore, a threshold value can be set for each task. The threshold values for tasks with the same priority can be set as the same. The threshold value for a task is configured to represent that a probability of completing the task is required to be no lower than the set threshold value when the control task is executed. When a member is selected from a task with a relatively low priority to join the present task, it will be examined whether a probability of completing the task with the relatively low priority is still no lower than the corresponding set threshold value if the selected member quits the another task with the relatively low priority. If so, the selected member is notified to quit the presently executed task with the relatively low priority and join the present task, otherwise the selected member does not quit the task with the relatively low priority.

If no member can be selected from the members executing a task with the lowest priority to join the present task, then whether a member can be selected from a task with a second lowest priority to join the present task can be examined. The same operation can be executed until members capable of joining the present task are found. If there are still no sufficient members joining the present task after all presently executed tasks with low priorities are searched, whether the control (e.g., blocking) can be implemented at the next-level branch points can be examined.

Furthermore, in the above process, if the selected member is between the target and the primary branch point to which it is allocated, or if the target is between the selected member and the primary branch point to which it is allocated, the member is confirmed and notified to arrive at the branch point before the target arrives at the primary branch point rather than rush to the primary branch point within the shortest time.

As shown in FIG. 1, when a member is selected for the primary branch point C3 and if the selected member is between O1 and C3, the controller (e.g., the cloud) confirms that the member moves according to a movement condition of the target. If the target moves to B3, the controller confirms and notifies the member to move to C3 following the target or monitor the target in situ. If the target moves to C3, the controller confirms and notifies the member to move to C3, and each member moves according to a received instruction so as to arrive at C3 before the target arrives at C3. When the member is selected for the primary branch point B3 and if a selected member is between O1 and C3, the controller (for example, the cloud) confirms and notifies the member to pass the target and arrive at a position between O1 and B3, and then to move according to the movement condition of the target. If the target moves to B3, the member is confirmed and notified to arrive at B3 before the target arrives at B3. Each member receiving the instruction moves according to the instruction.

When members are selected for the i^{th}-level branch point, where I≥2, if a selected member is between an i^{th}-level branch point and an (i−1)^{th}-level branch point, the selected member is confirmed and notified to preferably move to the (i−1)^{th}-level branch point rather than arrive at the i^{th}-level branch point at first. For example, when members are selected for a secondary branch point B2 and if a selected member for B2 is between B2 and B3, the member is confirmed and notified to move to B3 rather than arrive at B2 first, and each member receiving an instruction moves according to the instruction.

Furthermore, if the target has not yet arrived when the selected member arrives at a corresponding branch point, the member is confirmed and notified to continue moving towards the position of the target until meeting the target and completing the control (e.g., arresting), the task is completed, and the controller (for example, the cloud) confirms and notifies the member participating in the control to enter the idle state.

Furthermore, once a member has controlled (e.g. blocking) an immediate higher-level branch point in the control process, the controller (for example, the cloud) confirms that the control at any immediate lower-level branch point that is subdivided from the immediate higher-level branch point can be canceled, and the members can be released; and further confirms and notifies the member to change to an idle state or to recover its previous state (e.g., the member is executing a task with a relatively low priority before). In this example, for the target O1, if it is initially determined that the control at the point B3 cannot be implemented, and the control is switched at the secondary branch points B2, A3 and B4 instead. Then, because the target moves at a velocity lower than an expected velocity, the member designated to implement control at the point B4, after arriving at the point B4, continues moving towards the target and arrives at the point B3 earlier than the target. The controller (for example, the cloud) reserves the control member of this path, confirms the members designated to implement control at B2 and A3 to be released, and then notifies the members designated to implement control at B2 and A3 to be released.

Furthermore, cloud computing and control team analysis can be implemented in real time according to a certain frequency, so that team members may change at any time. For example, for the target O1, if control at the point B3 cannot be implemented initially but an individual member suddenly completes a previous task between O1 and B3, is in the idle state, and meets a condition set for the task, the member is immediately allocated to the control team for the task, and then all of the members previously designated to implement control at the secondary branch points B2, A3 and B4 can be immediately released.

In the above solution, the cloud can share real-time coordinates, images or real-time videos of the target to the whole control team, and information can be completely shared among the team members.

If a control task does not succeed finally, and the target, which needs to be arrested for example, breaches or breaks through the control and escapes, the controller (for example, the cloud) confirms each member to pursue the target at first, and meanwhile, the controller can recalculate to thereby re-arrange the control and build a new control team in real time according to the above steps until the target is controlled (e.g., arrested).

In the above mentioned embodiments of the target control method, the process of examining whether a target can be controlled is by means of level-by-level examinations at branch points of multiple levels, and the building and deployment of the control team can be dynamically regulated according to a present control state, and can be further implemented through a cloud computing in real time. As such, on the premise of ensuring the control over the target, the investment of personnel can be reduced as much as possible, and once a control at a higher-level branch point can be realized, a control at a lower-level branch point can be immediately released. Once the target breaches the control, the cloud can immediately compute or calculate a new control scheme, and thereby build and deploy a new control team. The information can be maintained to be synchronized among members in the control team until the task is completed or terminated. Therefore, the level of automation and the level of intelligence of the technical solution provided herein are far higher than those of present technologies, and represents a future direction.

After a target is discovered and locked, the cloud can analyze and determine a priority of a task for controlling the target based on various factors. Then a control team implementing the control task can be determined according to the priority, a present real-time velocity of the target, map information, and present states of robots/polices implementing the control in a certain range around the target. Then based on an intelligence algorithm, the respective moving route of each member can be determined and notified further to each member, and the control team can be universally coordinated in a real-time and dynamic manner based on a present global state during the control (e.g. surrounding and arresting) process over the target. When and if necessary, the cloud can control the joining of new members or can control the release of some present members under some conditions. Also, the information synchronization among members in the control team can be maintained until the task is completed or terminated. As such, the waste of additional control resources can be avoided on the premise of efficiently executing the task, and if the control team only, or mainly, includes robots, the risks on human members can be reduced.

In the technical solution disclosed above, the process of determining whether the target can be controlled can be realized through level-by-level examinations at branch points of multiple levels, and the control members can be dynamically regulated according to the present control state. The personnel investment can, on the premise of ensuring control, be reduced as much as possible, and a control at a lower-level branch point can be immediately released once a control at a higher-level branch point is realized. Once the target breaches the control, the cloud can also immediately compute the new control scheme and the new control team. The information is kept synchronized among the members in the team until the task is completed or terminated.

### Embodiment 2

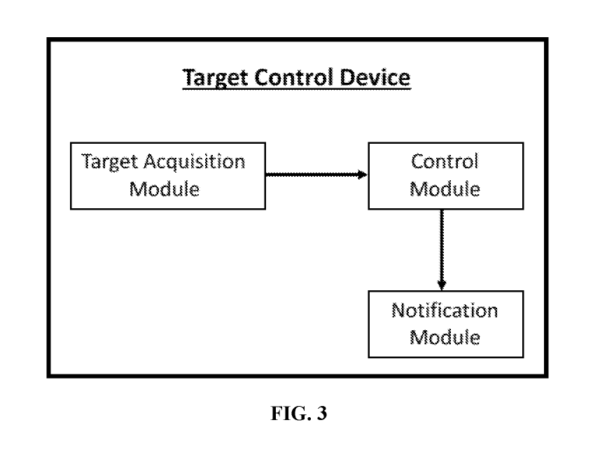

On the basis of the same inventive concept, embodiment 2 of the present disclosure provides a target control device. Implementation of the control device in the embodiment may refer to implementation of the control method in embodiment 1, and repeated parts will not be elaborated. As shown in FIG. 3, the device includes a target acquisition module, a control module, and a notification module.

The target acquisition module is configured to acquire a present position of a target.

The control module is configured, according to the present position of the target, to determine members controlling the target, and to determine a location where each member shall arrive, and a time when each member shall arrive at the location. Herein the location is a position where the target may be controlled, and some, or all, of the selected members can be robots. Herein, the control may be blocking, pursuing and attacking, chasing, rescuing or alike.

The notification module is configured to notify the designated location where and the designated time when each selected member shall arrive to the each selected member.

Furthermore, the operation that the target acquisition module acquires the present position of the target can include: acquiring the present position of the target on a map and at least primary branch points at which the target can be controlled. Herein, the at least primary branch points are positions where the members may control the target. The target acquisition module is further configured, when a control may not be realized at a branch point of a certain level, to determine an immediate next-level branch point of the branch point of the certain level. That is, when control may not be realized at a certain primary branch point, a secondary branch point of the primary branch point can be determined, and when control may not be realized at a certain secondary branch point, a tertiary branch point of the secondary branch point can be determined, and so on.

The operation that the control module determines the members controlling the target and determines the location where each member shall arrive according to the present position of the target can specifically include: for each primary branch point, determining whether at least one member can arrive before the target arrives at the branch point (i.e. each primary branch point) at a present maximum velocity. i.e. whether the time period for which any member arrives at the branch point at an average velocity does not exceed the time period for which the target arrives at the branch point at the present maximum velocity. If YES, the control module can select member for the primary branch point, and can then determine a time when each selected member arrives at the corresponding primary branch point. Herein, the time needs to be no later than the time when the target arrives at the branch point.

If no member can control the target at one or more primary branch points, i.e. if no member can rush to the branch point before the target arrives, the control module is further configured to search for each immediate next-level branch point, i.e., secondary branch point, of the primary branch point, to examine whether there is at least one member capable of implementing control at each secondary branch point, i.e., for each secondary branch point, whether at least one member can arrive at the secondary branch point before the target arrives at the secondary branch point at the present maximum velocity. If YES, the control module can select the at least one member, and determine a time when each of the at least one member arrives at the corresponding secondary branch point. Herein, the time needs to be no later than the time when the target arrives at the branch point at the present maximum velocity. If NO, the control module is further configured to search for an immediate next-level branch point for the branch point where no member can arrive before the target until the target can be controlled at the branch point, or a searched branch point level reaches a threshold value. When searching and examining whether there is at least one member that can implement a control over the target at a certain branch point, and if the branch point has been searched and examined before, the searching and examination may not be further performed.

The control module is configured, when selecting members for each branch point, to select different members for different branch points.

A maximum number of the branch point levels to be searched can be set as a threshold value, which may be set to be different for tasks with different priorities. After the threshold value is reached, the control over the target still may not be realized. Then, whether control may be completed at the primary branch points or not is examined. If a control over the target cannot be implemented under a present condition, a pursuing still proceeds, but computation is implemented in real time, and the position of the target on the map keeps changing, so that the target can be controlled (e.g., blocked) at a certain moment.

Furthermore, the device further includes a setting module.

The setting module is configured to set priorities for each task.

The control module is further configured, when selecting the members, to preferably select members in an idle state.

The control module is further configured, when selecting a member executing control for a certain branch point and if all of the members in the idle state cannot rush to the branch point before the target reaches the branch point, to select at least one member from another task having a lower priority than that of a present task to execute control at the branch point, and is further configured, if no member in each task with low priorities can arrive at the branch points before the target arrives at the present maximum velocity, to continuously search for an immediate next-level branch point of the branch point.

Furthermore, the setting module is further configured to set a threshold value for each task. The threshold values of tasks with the same priority can be same. The threshold value represents that a completion probability of the task is required to be no lower than the set threshold value when the control task is executed.

Furthermore, when the control module determines the location where a member should arrive, if the selected member is between a primary branch point and the target, (e.g. as illustrated in FIG. 1, if the selected member is between O1 and C3), the member is confirmed to move following the target or just to monitor the target in situ rather than rush to the primary branch point at first. If a selected member is between an i^{th}-level branch point and an (i−1)^{th} branch point when the member is selected for the i^{th}-level branch point, where i≥2, the member is confirmed to preferably move to the (i−1)^{th}-level branch point rather than arrive at the i^{th}-level branch point at first. For example, if a member selected for B2 is between B2 and B3 when the member is selected for the secondary branch point B2, the member moves to B3 rather than arrives at B2 at first.

The control module is further configured, when a member is selected from a task with a relatively low priority, to examine whether a completion probability of the task with the relatively low priority is still no lower than the corresponding set threshold value if the selected member quits the presently executed task, and if YES, to confirm that the selected member can quit the presently executed task and join the present task, and to determine a branch point where and time when the member should arrive, or if otherwise, to determine that the selected member cannot quit the presently executed task with the relatively low priority.

Furthermore, the control module is further configured, if the target has not yet arrived when the selected member arrives at the corresponding branch point, to determine that the member continues moving towards the target until meeting the target and completing the control, and then to update the members participating in the control to enter into the idle state or to recover a previous state after completion of the task.

The notification module is further configured to notify the members to continue moving towards the target until meeting the target and completing control and is further configured, after the task is completed, to notify all members executing the control task to enter the idle state or recover previous states.

The control module is further configured, if at least one member implementing control at a higher-level branch point in a control process, to cancel the control at a lower-level branch point subdivided from the branch point and to release members for the lower-level branch point, and to update a state of the members for the lower-level branch point into the idle state or recover its previous state.

The notification module is further configured, when members for one or more branch points are released, to notify the members to enter into the idle state or to recover previous states.

### Embodiment 3

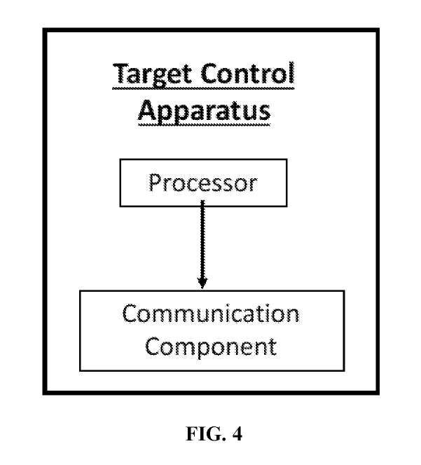

On the basis of the same inventive concept, embodiment 3 of the present disclosure also provides a target control apparatus. Implementation of the target control apparatus in the embodiment may refer to implementation of the control method in embodiment 1 and repeated parts will not be elaborated. As shown in FIG. 4, the apparatus includes a processor and a communication component.

The processor is configured to acquire a present position of a target to be controlled, and then, based on the present position of the target, to determine members controlling the target, a location where each member shall arrive and a time when each member shall reach the location. Herein, the location is a position where the target can be controlled; some or all of the selected members can be robots; and the control can be blocking or chasing.

The communication component is configured, for each selected member, to notify the specified location where and the specified time when each selected member shall arrive to the member.

Furthermore, the operation that the processor acquires the present position of the target to be controlled includes: acquiring the present position of the target on a map and at least primary branch points at which the target is controlled (herein, the at least primary branch points are positions where the members can control the target); The target acquisition module is further configured to, when control cannot be implemented or realized at a branch point of a certain level, determine an immediately next-level branch point of the branch point. That is, when control may not be implemented at a certain primary branch point, a secondary branch point of the primary branch point is determined; and when control cannot be implemented at a certain secondary branch point, a tertiary branch point of the secondary branch point is determined.

The operation that the processor determines the members controlling the target and the location where each member shall arrive based on the present position of the target specifically includes: for each determined primary branch point, examining whether at least one member can arrive before the target arrives at the branch point at a present maximum velocity (i.e. examining whether a time period for which the member arrives at the branch point at an average velocity does not exceed a time period for which the target arrives at the branch point at the present maximum velocity), and if YES, selecting the members for the primary branch point and determining a time when each member arrives at the corresponding primary branch point (herein, the time needs to be no later than the time when the target arrives at the branch point).

If no member can control the target at one or more primary branch points (i.e. no member can rush to the branch point before the target arrives), the processor further searches for each next-level branch point (i.e., secondary branch point) of the primary branch point, examines whether there is at least one member capable of implementing control at each secondary branch point or not (i.e., for each secondary branch point, whether at least one member can arrive at the secondary branch point before the target arrives at the secondary branch point at the present maximum velocity), and if YES, selects the at least one member and determines a time when each member arrives at the corresponding secondary branch point (herein, the time needs to be no later than time when the target arrives at the branch point).

When searching and examining whether there is at least one member that can implement a control over the target at a certain branch point, and if the branch point has been searched and examined before, the searching and examination may not be further performed.

The processor is configured, when selecting members for each branch point, to select different members for different branch points.

Furthermore, the apparatus further includes a setting component.

The setting component is configured to set priorities for each task.

The processor is configured, when selecting the members, to preferably select members in an idle state.

The processor is further configured, when selecting a member executing control for a certain branch point and if all of the members in the idle state cannot rush to the branch point before the target arrives, to select at least one member from a task having a lower priority than the present task to implement control at the branch point, and if no member in each task with low priorities can arrive before the target arrives at the branch points at the present maximum velocity, to search for a next-level branch point of the branch point.

Furthermore, the setting component is further configured to set a threshold value for each task. The threshold values of tasks with the same priority may be the same. The threshold value represents that a completion probability of the task is required to be no lower than the set threshold value when the control task is executed.

The processor is further configured, when a member is selected from a task with a relatively low priority, to examine whether a completion probability of the task with the relatively low priority is still no lower than the corresponding set threshold value if the selected member quits the presently executed task, and if YES, to determine that the selected member can quit the presently executed task and join the present task, and to determine a branch point where and a time when the member shall rush, or otherwise, to determine that the selected member cannot quit the presently executed task with the relatively low priority.

Furthermore, when the processor determines the location where a member shall arrive, if the selected member is between a primary branch point and the target (e.g. if the selected member is between O1 and C3, as shown in FIG. 1), the processor instructs that the member moves following the target or just monitors the target in situ rather than rushing to the primary branch point at first. If a selected member is between an i^{th}-level branch point and an (i−1)^{th} branch point when the member is selected for the i^{th}-level branch point, i≥2, the processor instructs that the member preferably moves to the (i−1)^{th}-level branch point rather than arrive at the i^{th}-level branch point at first. For example, if a member selected for B2 is between B2 and B3 when the member is selected for the secondary branch point B2, the member moves to B3 rather than arrives at B2 at first.

Furthermore, the processor is further configured, if the target has not yet arrived when the selected member arrives at the corresponding branch point, to determine and notify the member to continue moving towards the target until meeting the target and completing control, and to update the member participating in the control to enter into the idle state or to recover a previous state after the task is completed.

The communication component is further configured to notify the member to continue moving towards the target until meeting the target and completing control, and to notify all members executing the control task to enter into the idle state or to recover previous states after the task is completed.

The processor is further configured, if a member implementing control at a higher-level branch point in a control process, to determine to cancel control at a lower-level branch point subdivided from the branch point and to release members for the lower-level branch point and update a state of the members for the lower-level branch point into the idle state or recover their previous states.

The communication component is further configured, when members for one or more branch points are released, to notify the members to enter the idle state or recover previous states.

### Embodiment 4

On the basis of the same inventive concept, embodiment 4 of the present disclosure provides a computer-readable storage medium, which stores computer instructions configured to enable a computer to execute each step in the method of embodiment 1.

With adoption of the solutions of the present disclosure, after the target is discovered and locked, members are allocated in real time by cloud computing to control (e.g. block or chase) the target. In the present disclosure, some or all of the members for control can be robots, so that limitations caused by human control can be reduced as much as possible.

Furthermore, according to the technical solution provided herein, the process of determining whether the target can be controlled can be realized through level-by-level examinations at branch points of multiple levels, and the control members can be dynamically regulated according to the present control state. The personnel investment can, on the premise of ensuring control, be reduced as much as possible, and a control at a lower-level branch point can be immediately released once a control at a higher-level branch point is realized. Once the target breaches the control, the cloud can also immediately compute the new control scheme and the new control team. The information is kept synchronized among the members in the team until the task is completed or terminated.

Furthermore, the cloud can analyze and determine a priority of a task for controlling the target based on various factors. Then a control team implementing the control task can be determined according to the priority, a present real-time velocity of the target, map information, and present states of robots/polices implementing the control in a certain range around the target. Then based on an intelligence algorithm, the respective moving route of each member can be determined and notified further to each member, and the control team can be universally coordinated in a real-time and dynamic manner based on a present global state during the control (e.g. surrounding and arresting) process over the target. When and if necessary, the cloud can control the joining of new members or can control the release of some present members under some conditions. Also, the information synchronization among members in the control team can be maintained until the task is completed or terminated. As such, the waste of additional control resources can be avoided on the premise of efficiently executing the task, and if the control team only, or mainly, includes robots, the risks on human members can be reduced.

Those skilled in the art should know that the embodiment of the present disclosure may be provided as a method, a system or a computer program product. Therefore, the present disclosure may adopt a form of pure hardware embodiment, pure software embodiment or combined software and hardware embodiment. Moreover, the present disclosure may adopt a form of computer program product implemented on one or more computer-available storage media (including, but not limited to, a disk memory, a Compact Disc Read-Only Memory (CD-ROM) and an optical memory) including computer-available program codes.

The present disclosure is described with reference to flowcharts and/or block diagrams of the method, device (system) and computer program product according to the embodiments of the present disclosure. It is to be understood that each flow and/or block in the flowcharts and/or the block diagrams and combinations of the flows and/or blocks in the flowcharts and/or the block diagrams may be implemented by computer program instructions. These computer program instructions may be provided for a universal computer, a dedicated computer, an embedded processor or a processor of another programmable data processing device to generate a machine, so that a device for realizing a function specified in one flow or multiple flows in the flowcharts and/or one block or multiple blocks in the block diagrams is generated by the instructions executed through the computer or the processor of the other programmable data processing device.

These computer program instructions may also be stored in a computer-readable memory capable of guiding the computer or the other programmable data processing device to work in a specific manner, so that a product including an instruction device may be generated by the instructions stored in the computer-readable memory, the instruction device realizing the function specified in one flow or multiple flows in the flowcharts and/or one block or multiple blocks in the block diagrams.

These computer program instructions may further be loaded onto the computer or the other programmable data processing device, so that a series of operating steps are executed on the computer or the other programmable data processing device to generate processing implemented by the computer, and steps for realizing the function specified in one flow or multiple flows in the flowcharts and/or one block or multiple blocks in the block diagrams are provided by the instructions executed on the computer or the other programmable data processing device.

Although the preferred embodiments of the present disclosure have been described, those skilled in the art, once learning about basic creative concepts, may make other variations and modifications to these embodiments. Therefore, it is intended to explain the appended claims to include the preferred embodiments and all the variations and modifications falling within the scope of the present disclosure.

1. A method for controlling a target in a task, comprising:
acquiring a present position of the target; and
selecting, based on the present position of the target, at least one member designated for controlling the target, and determining a designated location where and a designated time when each of the at least one member shall arrive for controlling the target, and notifying the designated location and the designated time to the each selected member.

2. The method of claim 1, wherein the acquiring a present position of the target comprises:
obtaining, on a map, coordinates of the present position of the target and coordinates of branch points, wherein the branch points comprise at least 1^{st}-level branch points;
wherein:
in the at least one member designated for controlling the target, a different member is selected for each of the branch points.

3. The method of claim 2, wherein the selecting, based on the present position of the target, at least one member designated for controlling the target, and determining a designated location where and a designated time when each of the at least one member shall arrive for controlling the target, and notifying the designated location and the designated time to the each selected member comprises:
examining, for each 1^{st}-level branch point, whether one or more members is capable of arriving at the each 1^{st}-level branch point before the target arrives at a present maximum velocity; and
if so, selecting one of the one or more members as one of the at least one member designated for controlling the target at the each 1^{st}-level branch point;
or otherwise, performing at least one round of searching and examining corresponding to higher-level branch points, wherein one of the at least one round of searching and examining corresponding to i^{th}-level branch points comprises:
examining, for each i^{th}-level branch point, whether one or more members is capable of arriving at the each i^{th}-level branch point before the target arrives at a present maximum velocity; and
if so, selecting one of the one or more members as one of the at least one member designated for controlling the target at the each i^{th}-level branch point;
otherwise, performing another round of searching and examining corresponding to (i+1)^{th}-level branch points;
wherein i is an integer more than one.

4. The method of claim 3, wherein the performing at least one round of searching and examining continues until the target is controlled at the branch points or until a number of levels of the branch points reaches a first threshold value.

5. The method of claim 4, wherein the first threshold value is pre-determined according to a priority of the task.

6. The method of claim 2, wherein the selecting, based on the present position of the target, at least one member designated for controlling the target, and determining a designated location where and a designated time when each of the at least one member shall arrive for controlling the target, and notifying the designated location and the designated time to the each selected member comprises:
determining, for each of the branch points, whether one or more members in an idle state can be selected; and
if so, preferably selecting one of the one or more members for controlling the target at the each of the branch points; otherwise
selecting another member on another task having a lower priority for controlling the target at the each of the branch points.

7. The method of claim 6, wherein the selecting another member on another task having a lower priority for controlling the target at the each of the branch points comprises:
examining whether a probability of completing the another task if the another member quits the another task is no lower than a second threshold value; and
if so, notifying the another member to quit the another task and join the task; otherwise
maintaining the another member in the another task.

8. The method of claim 1, further comprising, prior to the selecting, based on the present position of the target, at least one member designated for controlling the target, and determining a designated location where and a designated time when each of the at least one member shall arrive for controlling the target, and notifying the designated location and the designated time to the each selected member:
setting a priority for the task based on information about the target;
wherein:
the selecting, based on the present position of the target, at least one member designated for controlling the target, and determining a designated location where and a designated time when each of the at least one member shall arrive for controlling the target, and notifying the designated location and the designated time to the each selected member comprises:
estimating, based on the priority for the task, a number of at least one member and a minimum capability for each of the at least one member required for the task.

9. The method of claim 1, further comprising:
altering a state of each of the at least one member designated for controlling the target into an idle state or a previous state upon completing of the task.

10. The method of claim 3, further comprising, if any one of the at least one member arrives at a higher-level branch point:
cancelling a control over the target at each lower-level branch point subdivided from the higher-level branch point; and
notifying each of the at least one member designated for each lower-level branch point to enter into an idle state or a previous state.

11. The method of claim 1, wherein one or more of the at least one member is a robot.

12. A device for allocating a task to a group of candidate members communicatively connected thereto to control a target, comprising:
a target acquisition module, configured to acquire a present position of the target;
a control module configured, based on the present position of the target, to select from the group of candidate members at least one member designated for the task, and to determine a designated location where and a designated time when each of the at least one member shall arrive for controlling the target; and
a notification module, configured to notify the designated location and the designated time to the each selected member.

13. The device of claim 12, wherein:
the target acquisition module is configured to obtain, on a map, coordinates of the present position of the target and coordinates of branch points, wherein the branch points comprise at least 1^{st}-level branch points; and
the control module is configured to select a different member for each of the branch points.

14. The device of claim 13, wherein the control module is configured:
to examine, for each 1^{st}-level branch point, whether one or more members is capable of arriving at the each 1^{st}-level branch point before the target arrives at a present maximum velocity; and
if so, to select one of the one or more members as one of the at least one member designated for controlling the target at the each 1^{st}-level branch point;
or otherwise, to perform at least one round of searching and examining corresponding to higher-level branch points, wherein one of the at least one round of searching and examining corresponding to i^{th}-level branch points comprises:
examining, for each i^{th}-level branch point, whether one or more members is capable of arriving at the each i^{th}-level branch point before the target arrives at a present maximum velocity; and
if so, selecting one of the one or more members as one of the at least one member designated for controlling the target at the each i^{th}-level branch point;
otherwise, performing another round of searching and examining corresponding to (i+1)^{th}-level branch points;
wherein i is an integer more than one.

15. The device of claim 12, further comprising a setting module, configured to set a priority for the task based on information about the target, wherein:
the control module is further configured to estimate, based on the priority for the task, a number of at least one member and a minimum capability for each of the at least one member required for the task.

16. The device of claim 14, further comprising a setting module, configured to set a priority for the task based on information about the target, wherein the control module is further configured:
to determine, for each of the branch points, whether one or more members in an idle state can be selected; and
if so, to preferably select one of the one or more members for controlling the target at the each of the branch points;
or otherwise, to select another member on another task having a lower priority for controlling the target at the each of the branch points.

17. The device of claim 14, wherein:
the control module is further configured, if any one of the at least one member arrives at a higher-level branch point, to cancel a control over the target at each lower-level branch point subdivided from the higher-level branch point; and
the notification module is further configured to notify each of the at least one member designated for each lower-level branch point to enter into an idle state or a previous state.

18. A system for controlling a target, comprising:
a control terminal, comprising a device according to claim 12; and
a group of candidate members, each communicatively connected to the control terminal, and configured to control the target under control of the control terminal.

19. The system of claim 18, wherein the control terminal is in a cloud.

20. The system of claim 18, wherein one or more of the group of candidate members is a robot.
